(19) United States
(12) Patent Application Publication
(10) Pub. No.: US 2015/0286093 A1
(43) Pub. Date: Oct. 8, 2015

(54) LIGHT SOURCE SYSTEM AND LIQUID CRYSTAL DISPLAY DEVICE INCLUDING THE SAME

(71) Applicant: Samsung Display Co., Ltd., Yongin-city (KR)

(72) Inventor: Sung Kyu SHIM, Seoul (KR)

(21) Appl. No.: 14/449,930

(22) Filed: Aug. 1, 2014

(30) Foreign Application Priority Data
Apr. 3, 2014 (KR) 10-2014-0040046

(51) Int. Cl. G02F 1/1335; F21V 17/06; F21V 5/04

(52) U.S. Cl. CPC G02F 1/133608; F21V 5/04; F21V 17/06; G02F 1/133606; G02F 1/133605; G02F 2001/133607

(57) ABSTRACT

A light source system comprises a substrate, a light source mounted on the substrate, a lens formed over the light source, and a plurality of support members supporting the lens. Each supporting member comprises an inner side surface, an outer side surface, a first connection side surface, and a second connection side surface. The distance between the light source and the outer side surface is greater than the distance between the light source and the inner side surface. The first connection side surface and the second connection side surface connect the inner side surface and the outer side surface. The inner side surface and the outer side surface are configured and oriented such that the light emitted by the light source is incident on the inner side surface and the outer side surface at a substantially perpendicular angle.

### CROSS-REFERENCE TO RELATED APPLICATION

This application claims priority to and the benefit of Korean Patent Application No. 10-2014-0040046 filed on Apr. 3, 2014 in the Korean Intellectual Property Office, the contents of which are herein incorporated by reference in their entirety.

### BACKGROUND

1. Technical Field

The present disclosure generally relates to a light source system and a liquid crystal display device including the same.

2. Description of the Related Art

A liquid crystal display device, which is one of widely used display devices, adjusts the amount of transmitted light by applying voltages to two electrodes (pixel electrode and common electrode) facing each other to control the arrangement of liquid crystal molecules of a liquid crystal layer interposed between the electrodes.

The liquid crystal display device requires a backlight unit for supplying light to a liquid crystal panel because the liquid crystal panel is configured as a non-luminescent element which cannot emit light itself.

Generally, the backlight unit includes a light source package including a light source for generating light, a light guide plate for guiding light from the light source to the liquid crystal panel, one or more optical sheets for enhancing the luminance and uniformity of light emitted from the light guide plate to the liquid crystal panel, and a reflective sheet disposed under the light guide plate.

Meanwhile, the light source package includes a substrate, a light source mounted on the substrate, and a lens coupled to the substrate to cover the light source. The lens is coupled to the substrate through cylindrical supporting portions formed at positions facing the side surfaces of the light source.

However, the cylindrical supporting portions may refract light emitted radially from the side surfaces of the light source such that the light travels in a distorted path. This is because light emitted from the side surfaces of the light source is not incident perpendicularly to the tangent of the cylindrical supporting portions when the light is incident on the supporting portions. In this case, the amount of light reaching the reflective sheet from the side surfaces of the light source is reduced. As a result, the amount of light supplied to the liquid crystal panel is reduced, and the luminance of the liquid crystal display device may be reduced.

### SUMMARY

An aspect of the present disclosure provides a light source package capable of minimizing a phenomenon in which the light emitted from the side surface of a light source is refracted and the traveling direction of the light is distorted.

Another aspect of the present disclosure provides a liquid crystal display device including a light source package capable of minimizing a phenomenon in which the light emitted from the side surface of a light source is refracted and the traveling direction of light is distorted.

However, aspects of the present disclosure are not limited to those set forth herein. The above and other aspects of the present disclosure will become more apparent to one of ordinary skill in the art to which the present disclosure pertains by referencing the detailed description given below.

In one aspect of the present disclosure, there is provided a light source package comprising: a substrate; a light source mounted on the substrate; and a lens having a body formed to cover the light source on the substrate, and a plurality of supporting portions formed in a columnar shape on a lower surface of the body to face side surfaces of the light source, wherein each of the supporting portions includes an inner side surface, an outer side surface which is more distant from the light source than the inner side surface and has an area larger than an area of the inner side surface, and a first connection side surface and a second connection side surface connecting the inner side surface to the outer side surface.

The supporting portions may be arranged on an imaginary circle having the same center as the light source.

The inner side surface may located on a first circle having a first radius among concentric circles having the same center as the light source, and the outer side surface may be located on a second circle having a second radius larger than the first radius among the concentric circles.

Each of the inner side surface and the outer side surface may be a flat or curved surface, and the first connection side surface and the second connection side surface may be flat surfaces.

The curved surface of the inner side surface is a surface on an arc of the first circle, and the curved surface of the outer side surface is a surface on an arc of the second circle.

A line extending to the light source along the first connection side surface and a line extending to the light source along the second connection side surface may pass through an inside of the light source.

A line extending to the light source along the first connection side surface and a line extending to the light source along the second connection side surface may pass through a center of the light source.

The supporting portions may include a first supporting portion to a fourth supporting portion, wherein the first supporting portion and the third supporting portion may be symmetric to each other with respect to a center of the light source, and the second supporting portion and the fourth supporting portion may be symmetric to each other with respect to the light source, and wherein a distance between the first supporting portion and the fourth supporting portion in a width direction of the substrate may be smaller than a distance between the first supporting portion and the second supporting portion in a longitudinal direction of the substrate.

According to another aspect of the present disclosure, a light source system comprises a substrate, a light source mounted on the substrate, a lens formed over the light source, and a plurality of support members supporting the lens. Each supporting member comprises an inner side surface, an outer side surface, a first connection side surface, and a second connection side surface. The distance between the light source and the outer side surface is greater than the distance between the light source and the inner side surface. The first connection side surface and the second connection side surface connect the inner side surface and the outer side surface. The inner side surface and the outer side surface are facing the light source.

The support members may comprise first, second, third, and fourth support members. The first support member and the third support member may be symmetrically located with respect to a center of the light source, and the second support member and the fourth support member may be symmetrically located with respect to the light source. The distance between the first support member and the fourth support member in a width direction of the substrate may be smaller than a distance between the first support member and the second support members in a longitudinal direction of the substrate.

The area of the outer side surface is larger than the area of the inner side surface.

The light emitted by the light source that enters the inner side surface of a support member generally exits the support member via the outer side surface thereof.

According to another aspect of the present disclosure, there is provided a light source package comprising: a substrate; a light source mounted on the substrate; and a lens having a body formed to cover the light source on the substrate, and a plurality of supporting portions formed in a columnar shape on a lower surface of the body to face side surfaces of the light source, wherein each of the supporting portions includes an outer side surface, and a first inner side surface and a second inner side surface connected to the outer side surface to form an acute angle between the first and second inner side surfaces.

The outer side surface may be located on a circle having the same center as the light source.

The outer side surface may be a flat or curved surface, and the first inner side surface and the second inner side surface may be flat surfaces.

The curved surface of the outer side surface may be a surface on an arc of the circle.

A line extending to the light source along the inner side surface and a line extending to the light source along the second inner side surface may pass through an inside of the light source.

According to another aspect of the present disclosure, a light source system comprises a substrate, a light source mounted on the substrate, a lens formed over the light source, and a plurality of support members supporting the lens, each support member comprising an outer side surface, a first connection side surface, and a second connection side surface. The first inner side surface and the second inner side surface are connected to the outer side surface and form an acute angle therebetween.

According to another aspect of the present disclosure, there is provided a liquid crystal display device comprising: a liquid crystal panel; and a light source package installed below the liquid crystal panel, wherein the light source package comprises: a substrate; a light source mounted on the substrate; and a lens having a body formed to cover the light source on the substrate, and a plurality of supporting portions formed in a columnar shape on a lower surface of the body to face side surfaces of the light source, wherein each of the supporting portions includes an inner side surface, an outer side surface which is more distant from the light source than the inner side surface and has an area larger than an area of the inner side surface, and a first connection side surface and a second connection side surface connecting the inner side surface to the outer side surface.

The supporting portions may be arranged on an imaginary circle having the same center as the light source.

The inner side surface may be located on a first circle having a first radius among concentric circles having the same center as the light source, and the outer side surface may be located on a second circle having a second radius larger than the first radius among the concentric circles.

Each of the inner side surface and the outer side surface may be a flat or curved surface, and the first connection side surface and the second connection side surface may be flat surfaces.

A line extending to the light source along the first connection side surface and a line extending to the light source along the second connection side surface may pass through an inside of the light source.

The supporting portions may include a first supporting portion to a fourth supporting portion, wherein the first supporting portion and the third supporting portion may be symmetric to each other with respect to a center of the light source, and the second supporting portion and the fourth supporting portion may be symmetric to each other with respect to the light source, and wherein a distance between the first supporting portion and the fourth supporting portion in a width direction of the substrate may be smaller than a distance between the first supporting portion and the second supporting portion in a longitudinal direction of the substrate.

The liquid crystal display device may further comprise: a bottom chassis accommodating the light source package; and a reflective sheet disposed on the bottom chassis to surround the lens.

According to another aspect of the present disclosure, a liquid crystal displace device comprises a liquid crystal panel and a light source system disposed below the liquid crystal panel. The light source system comprises a substrate, a light source mounted on the substrate, a lens formed over the light source, a plurality of support members supporting the lens, each support member comprising an outer side surface, a first connection side surface, and a second connection side surface. The distance between the light source and the outer side surface is greater than the distance between the light source and the inner side surface. The first connection side surface and the second connection side surface connect the inner side surface and the outer side surface. The inner side surface and the outer side surface are oriented such that the light emitted by the light source is incident on the inner side surface and the outer side surface at a substantially perpendicular angle.

The support members may comprise first, second, third, and fourth support members. The first support member and the third support member may be symmetrically located with respect to a center of the light source, and the second support member and the fourth support member may be symmetrically located with respect to the light source. The distance between the first support member and the fourth support member in a width direction of the substrate may be smaller than a distance between the first support member and the second support members in a longitudinal direction of the substrate.

Embodiments of the present disclosure may provide one or more of the following effects.

A light source package according to an embodiment of the present disclosure includes columnar supporting portions, each supporting portion having an inner side surface, an outer side surface, a first connection side surface, and a second connection side surface. Thus, it is possible to cause the light emitted from the side surface of a light source to be incident on the supporting portion at an angle that is substantially perpendicular to the plane that is tangent to the supporting portion. Therefore, it is possible to minimize the phenomenon in which the light emitted from the side surface of the light source is refracted to travel in a distorted path. In a liquid crystal display device including the light source package described above, it is possible to minimize the reduction in the amount of light emitted from the side surface of the light source when the light is incident on a reflective sheet. Therefore, it is possible to minimize the phenomenon in which the amount of light incident on the reflective sheet from the side surface of the light source decreases, thereby causing the amount of light provided to the liquid crystal panel to be reduced. Accordingly, the reduction in the luminance of the liquid crystal display device can be minimized.

The effects of the various embodiments of the present disclosure are not limited to the above-described effects and other effects which are not described herein will become apparent to those skilled in the art from the following description.

### BRIEF DESCRIPTION OF THE DRAWINGS

The above and other aspects and features of the present inventive concept will become more apparent by describing in detail exemplary embodiments thereof with reference to the attached drawings, in which:

FIG. 1 is a perspective view schematically showing a light source package according to an embodiment of the present disclosure;

FIG. 2 is a cross-sectional view taken along line A-A of FIG. 1;

FIG. 3 is a perspective view of a supporting portion of a lens shown in FIG. 2;

FIG. 4 is a plan view showing an arrangement relationship between a substrate and a light source and supporting portions of the lens of FIG. 2;

FIG. 5 is a plan view showing a traveling path of light emitted from the side surface of a light source to supporting portions in a light source package according to another example;

FIG. 6 is a plan view showing a traveling path of light emitted from the side surface of the light source to the supporting portions in the light source package according to the embodiment of the present disclosure;

FIGS. 7 to 15 are perspective views and plan views showing various embodiments of the supporting portions of FIG. 2;

FIG. 16 is an exploded perspective view schematically showing a liquid crystal display device including the light source package according to the embodiment of the present disclosure;

FIG. 17 is a cross-sectional view taken along line B-B of FIG. 16;

FIG. 18 is a spectrum showing the amount of light reaching a reflective sheet from a light source package according to another example; and

FIG. 19 is a spectrum showing the amount of light reaching the reflective sheet from the light source package according to the embodiment of the present disclosure.

### DETAILED DESCRIPTION OF THE EMBODIMENTS

Advantages and features of the present invention and methods of accomplishing the same may be understood more readily by reference to the following detailed description of various embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims.

It will also be understood that when a layer is referred to as being “on” another layer or substrate, it can be directly on the other layer or substrate, or intervening layers may also be present. The same reference numbers indicate the same components throughout the specification.

It will be understood that, although the terms “first,” “second,” “third,” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer or section discussed below could be termed a second element, component, region, layer, or section without departing from the teachings of the present disclosure.

Hereinafter, various embodiments of the present disclosure will be described in detail with reference to the accompanying drawings.

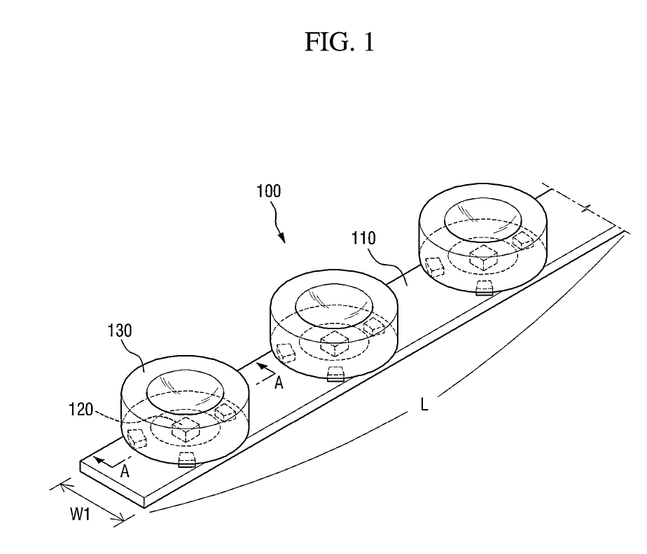

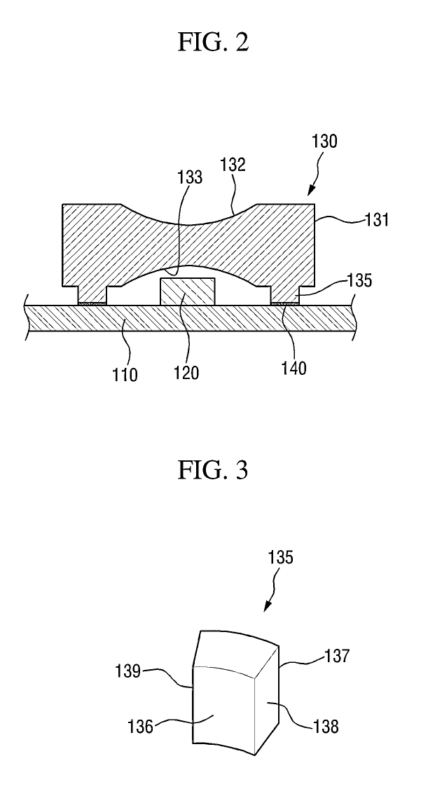

FIG. 1 is a perspective view schematically showing a light source package according to an embodiment of the present disclosure, and FIG. 2 is a cross-sectional view taken along line A-A of FIG. 1.

Referring to FIGS. 1 and 2, a light source package 100 according to the embodiment of the present disclosure includes a substrate 110, a light source 120, a lens 130 and an adhesive layer 140.

The substrate 110 may be formed as a printed circuit board (PCB). A circuit pattern (not shown) for driving the light source 120 is formed on the substrate 110, and the circuit pattern is electrically connected to the light source 120. The substrate 110 may have a rectangular bar shape having a length L and a width W1.

The light source 120 is mounted on the substrate 110, and may be a light emitting diode (LED). The light source 120 may emit light laterally as well as upwardly. The light source 120 may comprise a plurality of light sources installed on the substrate 110 in a longitudinal direction.

The lens 130 uniformly spreads the light emitted from the light source 120, and may include a body 131 and a plurality of supporting portions 135.

The body 131 covers the light source 120 disposed on the substrate 110, and may be separated or spaced apart from the substrate 110 by the plurality of supporting portions 135. The body 131 may have a columnar shape. A first recess 132 may be formed in an upper portion of the body 131, and a second recess 133 may be formed in a lower portion of the body 131. The body 131 may uniformly spread the light emitted from the light source 120 in a lateral direction (e.g., left or right direction in FIG. 2) as well as a forward direction (e.g., upward direction in FIG. 2) of the lens 130.

The supporting portions 135 may be formed on a lower surface of the body 131, and may be arranged such that one or more side surfaces thereof are facing the side surfaces of the light source 120. The plurality of supporting portions 135 may stably support the body 131. In the example of FIG. 2, the plurality of supporting portions 135 are integrally formed with the body 131. For example, the lens 130 including the body 131 and the plurality of supporting portions 135 is formed as a single unit. However, the lens 130 is not limited to such a configuration. In another embodiment, the body 131 and the plurality of supporting portions 135 are separately formed and attached together to form the lens 130.

The adhesive layer 140 may be formed by interposing an adhesive between the lower surfaces of the supporting portions 135 and the upper surface of the substrate 110 in order to fix the lens 130 to the substrate 110.

The light source package 100 configured as described above may be installed under a display device, e.g., a liquid crystal panel of a liquid crystal display device, for displaying an image using light supplied from a separate source.

Hereinafter, the supporting portions 135 of the lens 130 will be described in detail.

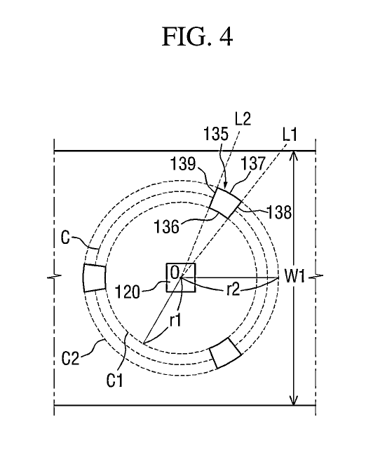

FIG. 3 is a perspective view of the supporting portion of the lens shown in FIG. 2, and FIG. 4 is a plan view illustrating the spatial relationship among the substrate, the light source, and the supporting portions of the lens of FIG. 2.

Referring to FIGS. 3 and 4, the supporting portions 135 may be spaced apart from each other such that each of the supporting portions 135 is disposed on an imaginary circle C centered at a center O of the light source 120 when viewed in a direction perpendicular to the major surface of the substrate 110. Each of the supporting portions 135 has a columnar shape, and may include an inner side surface 136, an outer side surface 137, a first connection side surface 138, and a second connection side surface 139. In one embodiment, each of the side surfaces 136-139 is perpendicular to the major surface of the substrate 110.

The inner side surface 136 is a side surface facing the side surface of the light source 120, and is located on a first circle C1 having a first radius r1 among concentric circles C1 and C2 centered at the center O of the light source 120. The shape of the inner side surface 136 causes the light emitted from the side surface of the light source 120 to be incident on the inner side surface 136 at an angle that is substantially perpendicular to the plane that is tangential to the inner side surface 136, thereby minimizing the refraction of the light at the inner side surface 136, which may cause the light to travel along a distorted path. The inner side surface 136 may be a curved surface (e.g., concave if viewed from a direction extending from the light source 120 to the supporting portion 135), and may coincide with a portion of an arc of the first circle C1.

In one example, the phrase “substantially perpendicular” as used herein may mean, in addition to its ordinary meaning, that the light emitted from the center of the light source is incident on the surface of the supporting portion at a perpendicular angle. In another example, the phrase “substantially perpendicular” may mean, in addition to its ordinary meaning, that a threshold percentage of the light emitted from the light source that enters the surface of the supporting portion does so perpendicularly with respect to the surface. In one embodiment, the threshold percentage is one of 99%, 95%, 90%, 75%, and 50%. The threshold percentage is not limited to those numbers listed herein, and can be any other arbitrary number.

In another embodiment, the light emitted from the light source that enters the inner side surface 136 of the supporting portion 135 generally exits the supporting portion 135 via the outer side surface 137. In one example, the phrase “generally exits” may mean, in addition to its ordinary meaning, that a threshold percentage of the light entering the inner side surface 136 exits the supporting portion 135 via the outer side surface 137. In one embodiment, the threshold percentage is one of 99%, 95%, 90%, 75%, and 50%. The threshold percentage is not limited to those numbers listed herein, and can be any other arbitrary number.

The outer side surface 137 is more distant from the light source 120 than the inner side surface 136, and is located on a second circle C2 having a second radius r2 among the concentric circles C1 and C2. The outer side surface 137 causes the light emitted from the side surface of the light source 120 to be incident on the outer side surface 137 at an angle that is perpendicular to the plane that is tangential to the outer side surface 137, thereby minimizing the refraction of the light at the outer side surface 137, which may cause the light to travel along a distorted path. The outer side surface 137 may have an area larger than an area of the inner side surface 136. The outer side surface 137 may be a curved surface (e.g., concave if viewed from a direction extending from the light source 120 to the supporting portion 135), and may coincide with a portion of an arc of the second circle C2.

The first connection side surface 138 and the second connection side surface 139 are side surfaces connecting the inner side surface 136 to the outer side surface 137. A line L1 extending from the first connection side surface 138 to the light source 120 and a line L2 extending from the second connection side surface 139 to the light source 120 may pass through the inside, e.g., the center O, of the light source 120. Since the first connection side surface 138 and the second connection side surface 139 are parallel with a normal path of light emitted from the side surface of the light source 120, they may not cause any refraction of the light emitted from the side surface of the light source 120. For example, the normal path of light may refer to a path in which light travels in a straight direction without refraction.

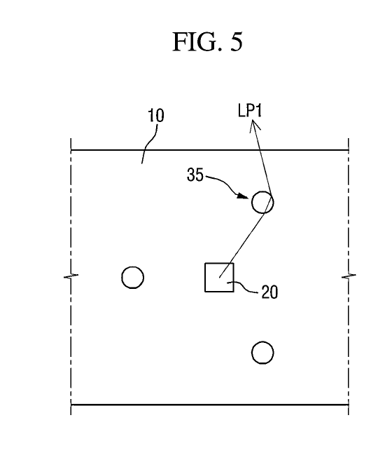

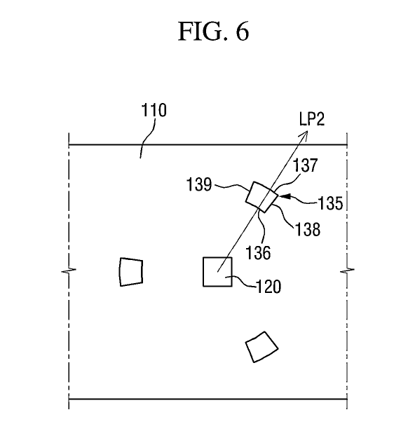

The supporting portions 135 having the above-described structure minimize the phenomenon in which the light emitted from the side surface of the light source 120 is refracted to travel along a distorted path, which can be seen from FIGS. 5 and 6.

FIG. 5 is a plan view showing a traveling path of light emitted from the side surface of a light source to supporting portions in a light source package according to another example. FIG. 6 is a plan view showing a traveling path of light emitted from the side surface of the light source to the supporting portions in the light source package according to an embodiment of the present disclosure.

As shown in FIG. 5, the light source package according to the example of FIG. 5 includes cylindrical supporting portions 35 facing the side surfaces of a light source 20 on a substrate 10. In this case, it can be seen that when the light emitted from the side surface of the light source 20 enters the supporting portion 35, the light does not enter the surface thereof at an angle that is perpendicular to the tangential plane at the point of entry, and the light traveling path is changed due to refraction.

On the other hand, the light source package according to the embodiment of the present disclosure includes the supporting portions 135, each having the inner side surface 136 facing the side surface of the light source 120 on the substrate 110, the outer side surface 137, the first connection side surface 138, and the second connection side surface 139. In this case, it can be seen that when the light emitted from the side surface of the light source 120 enters the supporting portion 135, the light enters the supporting portion 135 at an angle that is perpendicular to the tangential plane at the point of entry, (e.g., the tangential plane at the inner side surface 136 and the tangential plane at the outer side surface 137), and the light traveling path is not changed.

Hereinafter, various shapes that supporting portions of the lens of the above-described light source package can have will be described.

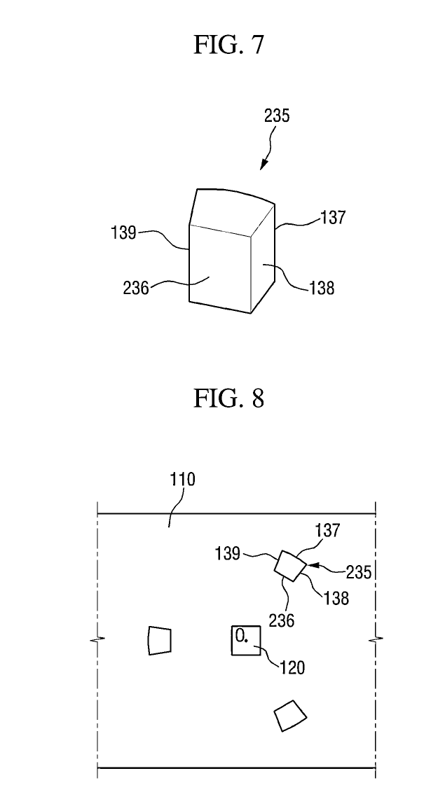

FIGS. 7 to 15 are perspective views and plan views showing various embodiments of the supporting portions of FIG. 2.

FIGS. 7 and 8 illustrate that each of supporting portions 235 includes an inner side surface 236, the outer side surface 137, the first connection side surface 138, and the second connection side surface 139. The supporting portions 235 are different from the supporting portions 135 of FIGS. 3 and 4 only in that the inner side surface 236 is a flat surface. The supporting portions 235 provide an effect similar to that of the supporting portions 135 of FIGS. 3 and 4. However, since the inner side surface 236 of the supporting portion 235 is flat, the lens can be manufactured more easily (e.g., in the case that the lens having supporting portions is manufactured by cutting a raw material).

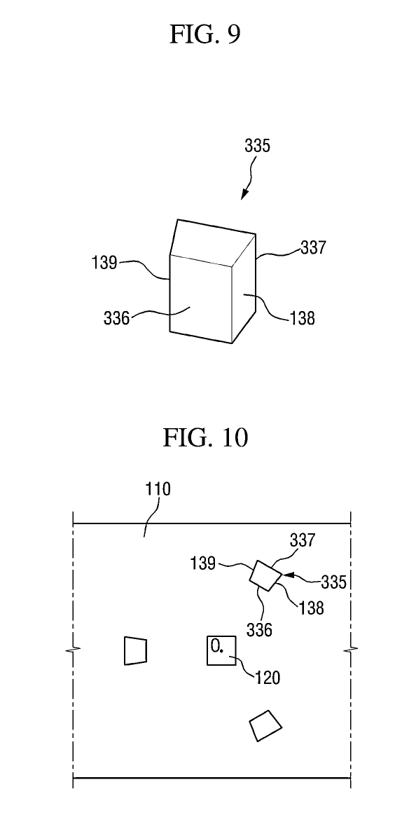

FIGS. 9 and 10 illustrate that each of supporting portions 335 includes an inner side surface 336, an outer side surface 337, the first connection side surface 138 and the second connection side surface 139. The supporting portions 335 are different from the supporting portions 135 of FIGS. 3 and 4 only in that the inner side surface 336 and the outer side surface 337 are flat surfaces. The supporting portions 335 provide an effect similar to that of the supporting portions 135 of FIGS. 3 and 4. However, as discussed above, since the inner side surface 336 and the outer side surface 337 of the supporting portion 335 are flat, the lens can be manufactured more easily.

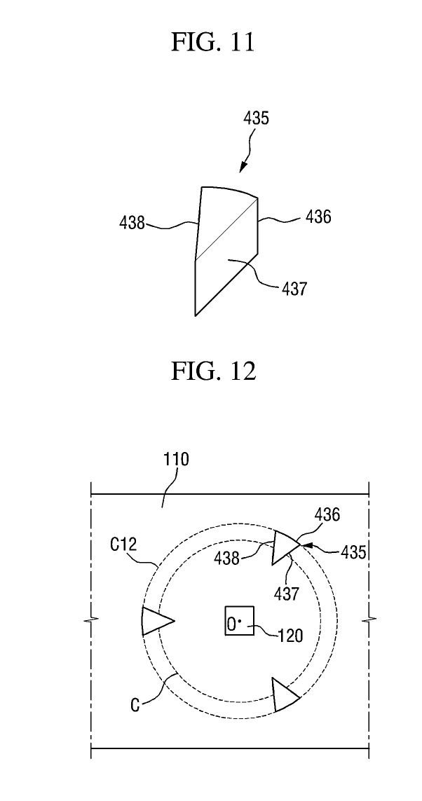

FIGS. 11 and 12 illustrate that a plurality of supporting portions 435 are spaced apart from each other such that each of the supporting portions 435 is disposed on the imaginary circle C centered at the center O of the light source 120 when viewed in a direction perpendicular to the major surface of the substrate 110, and each of the supporting portions 435 includes three side surfaces. For example, each of the supporting portions 435 may include an outer side surface 436, a first inner side surface 437, and a second inner side surface 438.

The outer side surface 436 is located on a circle C12 centered at the center O of the light source 120. The outer side surface 436 causes the light emitted from the side surface of the light source 120 to be incident on the outer side surface 436 at an angle that is perpendicular to the plane that is tangential to the outer side surface 436, thereby minimizing the refraction of the light at the outer side surface 436, which may cause the light is refracted to travel along a distorted path. The outer side surface 436 may be a curved surface (e.g., concave if viewed from a direction extending from the light source 120 to the supporting portion 435), and may coincide with a portion of an arc of the circle C12.

The first inner side surface 437 and the second inner side surface 438 are surfaces connected to the outer side surface 436 to form an acute angle between them. A width between the first inner side surface 437 and the second inner side surface 438 may be relatively smaller than a width between the first connection side surface 138 and the second connection side surface 139 of FIGS. 3 and 4. By providing the first inner side surface 437 and the second inner side surface 438, it is possible to minimize the extent to which the supporting portion 435 serves as a barrier to the light emitted from the side surface of the light source 120, and increase the discharge of heat generated from the substrate 110.

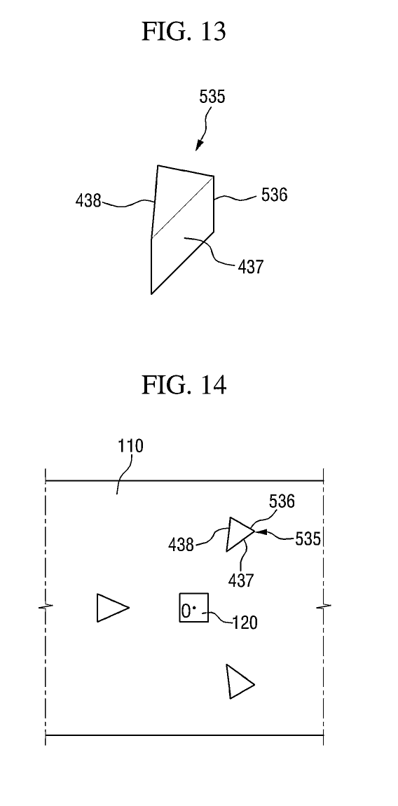

FIGS. 13 and 14 illustrate that each of supporting portions 535 includes an outer side surface 536, a first inner side surface 437, and a second inner side surface 438. The supporting portions 535 are different from the supporting portions 435 of FIGS. 11 and 12 only in that the outer side surface 536 is a flat surface. The supporting portions 535 provide an effect similar to that of the supporting portions 435 of FIGS. 11 and 12. However, as discussed above, since the outer side surface 536 of the supporting portion 535 is flat, the lens can be manufactured more easily.

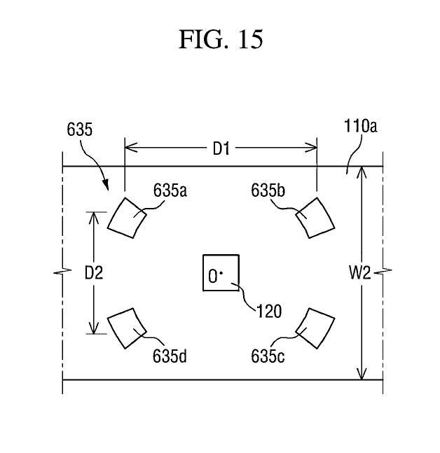

FIG. 15 illustrates four supporting portions 635 installed on a substrate 110a. In the example of FIG. 15, the supporting portions 635 include a first supporting portion 635a, a second supporting portion 635b, a third supporting portion 635c, and a fourth supporting portion 635d. The first supporting portion 635a and the third supporting portion 635c may be symmetric to each other with respect to the center O of the light source 120. Further, the second supporting portion 635b and the fourth supporting portion 635d may be symmetric to each other with respect to the center O of the light source 120. In this case, a distance D2 between the first supporting portion 635a and the fourth supporting portion 635d in the width direction of the substrate 110a may be smaller than a distance D1 between the first supporting portion 635a and the second supporting portion 635b in the longitudinal direction of the substrate 110a. In one embodiment, the distance D2 between the first supporting portion 635a and the fourth supporting portion 635d is shorter than a threshold percentage of the distance D1 between the first supporting portion 635a and the second supporting portion 635b. In one embodiment, the threshold percentage is one of 90%, 80%, 70%, 60%, and 50%. The threshold percentage is not limited to those numbers listed herein, and can be any other arbitrary number. By providing the supporting portions 635, it is possible to stably couple the lens to the substrate 110a, and the width of the substrate necessary to dispose the lens can be reduced to a width W2 smaller than a width W1 of the substrate 110 of FIG. 4.

As described above, the light source package 100 according to the embodiment of the present disclosure includes the columnar supporting portions 135, each having the inner side surface 136, the outer side surface 137, the first connection side surface 138, and the second connection side surface 139. Thus, it is possible to cause the light emitted from the side surface of the light source 120 to be incident on the supporting portion 135 at an angle that is perpendicular to the plane that is tangential to the surface of the supporting portion 135.

Therefore, in the light source package 100 according to the embodiment of the present disclosure, it is possible to minimize a phenomenon in which the light emitted from the side surface of the light source 120 is refracted to travel along a distorted path.

Next, a liquid crystal display device including a light source package according to an embodiment of the present disclosure will be described.

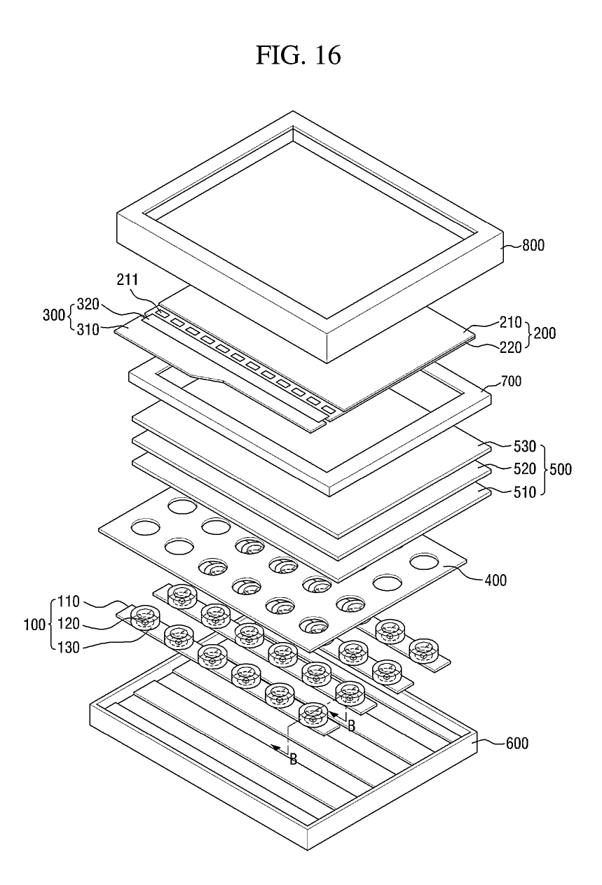

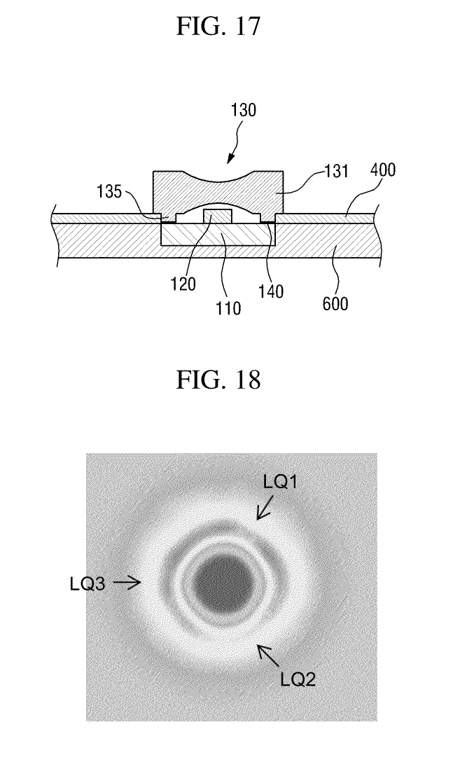

FIG. 16 is an exploded perspective view schematically showing a liquid crystal display device including the light source package according to the embodiment of the present disclosure. FIG. 17 is a cross-sectional view taken along line B-B of FIG. 16.

As shown in FIGS. 16 and 17, the liquid crystal display device may include the light source package 100, a liquid crystal panel 200, a driving circuit unit 300, a reflective sheet 400, a plurality of optical sheets 500, a bottom chassis 600, a mold frame 700, and a top chassis 800.

The light source package 100 is installed below the liquid crystal panel 200, and provides light to the liquid crystal panel 200 to display an image on the liquid crystal panel 200. Since the light source package 100 has been fully described above, a detailed description thereof will be omitted.

The liquid crystal panel 200 may include a color filter substrate 210 and a thin film transistor (TFT) substrate 220. A liquid crystal layer (not shown) containing liquid crystal molecules is included between the color filter substrate 210 and the TFT substrate 220. The arrangement of liquid crystal molecules may be controlled according to the application of a driving signal to display an image on the liquid crystal panel.

The driving circuit unit 300 is connected to one side of the liquid crystal panel 200 to apply a driving signal to the liquid crystal panel 200. The driving circuit unit 300 may include a printed circuit board 310 that receives and provides an external data signal and a power supply signal, and a flexible printed circuit board 320 that connects between the printed circuit board 310 and the liquid crystal panel 200. A control IC 311 may be mounted on the flexible printed circuit board 320.

The reflective sheet 400 is formed on the bottom chassis 600 to surround the light source 120 of the light source package 100. The reflective sheet 400 reflects the light emitted from the light source 120 toward the liquid crystal panel 200. In this case, the supporting portions 135 of the lens 130 may minimize the phenomenon in which the light emitted from the side surface of the light source 120 is refracted and the amount of light incident on the reflective sheet 400 is thereby reduced.

The plurality of optical sheets 500 may include a diffusion sheet 510, a polarization sheet 520, and a luminance enhancing sheet 530. The diffusion sheet 510 orients the light emitted from the light source package 100 toward the front surface of the liquid crystal panel 200, and diffuses the light to have a uniform distribution in a wide range to illuminate the liquid crystal panel 200. The polarization sheet 520 serves to change the light incident obliquely, as a part of the light incident on the polarization sheet 520, to be emitted perpendicularly. For example, at least one polarization sheet 520 may be disposed below the liquid crystal panel 200 in order to convert the light from the diffusion sheet 510 into a light of a particular polarization. The luminance enhancing sheet 530 transmits light parallel to a transmission axis and reflects light perpendicular to the transmission axis. Although not shown, a light guide plate may be further disposed below the plurality of optical sheets 500 to guide light from the light source package 100 toward the liquid crystal panel 200.

The bottom chassis 600 accommodates the light source package 100, the reflective sheet 400, and the optical sheets 500. The mold frame 700 fixedly supports the light source package 100, the reflective sheet 400, and the optical sheets 500. The top chassis 800 prevents the liquid crystal panel 200 from being separated.

As described above, the liquid crystal display device includes the light source package 100 including the columnar supporting portions 135, each having the inner side surface 136 (e.g., see FIG. 2), the outer side surface 137 (e.g., see FIG. 2), the first connection side surface 138 (e.g., see FIG. 2), and the second connection side surface 139 (e.g., see FIG. 2). Thus, it is possible to minimize the reduction in the amount of light emitted from the side surface of the light source 120 when the light is incident on the reflective sheet 400.

Therefore, the liquid crystal display device can minimize the phenomenon in which the amount of light incident on the reflective sheet 400 from the side surface of the light source 120 decreases, thereby causing the amount of light provided to the liquid crystal panel 200 to be reduced. Accordingly, the reduction in the luminance of the liquid crystal display device can be minimized

Next, the results of a simulation for demonstrating an effect of minimizing a reduction in the amount of light incident on the reflective sheet 400 from the side surface of the light source 120 in the light source package 100 will be described.

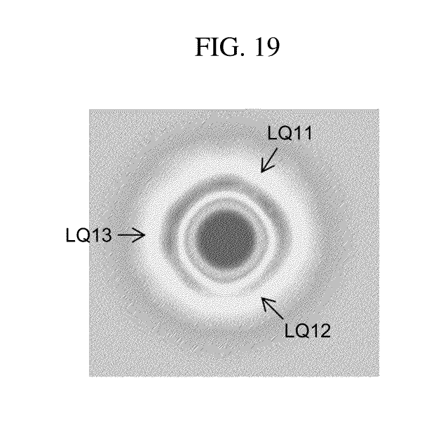

FIG. 18 is a spectrum showing the amount of light reaching a reflective sheet from side surfaces of a light source in a light source package according to another example. FIG. 19 is a spectrum showing the amount of light reaching the reflective sheet from the side surfaces of the light source in the light source package according to the embodiment of the present disclosure.

The light source package according to the example of FIG. 18 has a structure including a lens having cylindrical supporting portions. In this case, it can be seen that the amount of light is reduced in some portions LQ1, LQ2, and LQ3 of FIG. 18. On the other hand, the light source package 100 (e.g., see FIG. 2) according to the embodiment of the present disclosure has a structure including the lens 130 (e.g., see FIG. 2) having the columnar supporting portions 135 (e.g., see FIG. 3), each having the inner side surface 136 (e.g., see FIG. 3), the outer side surface 137 (e.g., see FIG. 3), the first connection side surface 138 (e.g., see FIG. 3) and the second connection side surface 139 (e.g., see FIG. 3). In this case, it can be seen that a reduction in the amount of light in portions LQ11, LQ12, and LQ13 of FIG. 19 corresponding to the portions LQ1, LQ2, and LQ3 of FIG. 18 is smaller than that in the portions LQ1, LQ2, and LQ3 of FIG. 18.

In concluding the detailed description, those skilled in the art will appreciate that many variations and modifications can be made to the disclosed embodiments without substantially departing from the principles of the present disclosure. Therefore, the disclosed embodiments of the present disclosure are used in a generic and descriptive sense only and not for purposes of limitation.

What is claimed is:

1. A light source system comprising:
a substrate;
a light source mounted on the substrate;
a lens formed over the light source; and ,
a plurality of support members supporting the lens, each support member comprising an inner side surface, an outer side surface, a first connection side surface, and a second connection side surface, a distance between the light source and the outer side surface being greater than a distance between the light source and the inner side surface, and the first connection side surface and the second connection side surface connecting the inner side surface and the outer side surface,
wherein the inner side surface and the outer side surface are configured and oriented such that the light emitted by the light source is incident on the inner side surface and the outer side surface at a substantially perpendicular angle.

2. The light source system of claim 1, wherein the support members coincide with at least a portion of an imaginary circle whose center coincides with the center of the light source.

3. The light source system of claim 1, wherein the inner side surface coincides with at least a portion of a first circle having a first radius among concentric circles having the same center as the light source, and the outer side surface coincides with at least a portion of a second circle having a second radius larger than the first radius among the concentric circles.

4. The light source system of claim 1, wherein each of the inner side surface and the outer side surface is a flat or substantially flat surface, and the first connection side surface and the second connection side surface are flat surfaces, wherein each of the inner and outer side surfaces is configured and oriented such that the light emitted by the light source is incident on at least a portion thereof at a substantially perpendicular angle.

5. The light source system of claim 1, wherein each of the inner side surface and the outer side surface is a curved surface, and the first and second connection side surfaces are flat surfaces, and wherein the curved surface of the inner side surface coincides with an arc of the first circle, and the curved surface of the outer side surface coincides with an arc of the second circle.

6. The light source system of claim 1, wherein a line extending to the light source along the first connection side surface and a line extending to the light source along the second connection side surface pass through an inside of the light source.

7. The light source system of claim 1, wherein a line extending to the light source along the first connection side surface and a line extending to the light source along the second connection side surface pass through a center of the light source.

8. The light source system of claim 1, wherein the support members comprise first, second, third, and fourth support members,
wherein the first support member and the third support member are symmetrically located with respect to a center of the light source, and the second support member and the fourth support member are symmetrically located with respect to the light source, and
wherein a distance between the first support member and the fourth support member in a width direction of the substrate is smaller than a distance between the first support member and the second support members in a longitudinal direction of the substrate.

9. A light source system comprising:
a substrate;
a light source mounted on the substrate;
a lens formed over the light source; and
a plurality of support members supporting the lens, each support member comprising an outer side surface, a first connection side surface, and a second connection side surface, the first inner side surface and the second inner side surface connected to the outer side surface and forming an acute angle therebetween.

10. The light source system of claim 9, wherein the outer side surface is located on a circle having the same center as the light source.

11. The light source system of claim 10, wherein the outer side surface is a flat or substantially flat surface, and the first inner side surface and the second inner side surface are flat surfaces, wherein each of the inner and outer side surfaces is configured and oriented such that the light emitted by the light source is incident on at least a portion thereof at a substantially perpendicular angle.

12. The light source system of claim 11, wherein the outer side surface is curved surface, and the curved surface of the outer side surface coincides with on an arc of the circle.

13. The light source system of claim 11, wherein a line extending to the light source along the inner side surface and a line extending to the light source along the second inner side surface pass through an inside of the light source.

14. A liquid crystal display device comprising:
a liquid crystal panel; and
a light source system disposed below the liquid crystal panel,
wherein the light source system comprises:
a substrate;
a light source mounted on the substrate;
a lens formed over the light source; and
a plurality of support members supporting the lens, each support member comprising an outer side surface, a first connection side surface, and a second connection side surface, a distance between the light source and the outer side surface being greater than a distance between the light source and the inner side surface, and the first connection side surface and the second connection side surface connecting the inner side surface and the outer side surface,
wherein the inner side surface and the outer side surface are configured and oriented such that the light emitted by the light source is incident on the inner side surface and the outer side surface at a substantially perpendicular angle.

15. The liquid crystal display device of claim 14, wherein the support members coincide with at least a portion of an imaginary circle whose center coincides with a center of the light source.

16. The liquid crystal display device of claim 14, wherein the inner side surface is located on a first circle having a first radius among concentric circles having the same center as the light source, and the outer side surface is located on a second circle having a second radius larger than the first radius among the concentric circles.

17. The liquid crystal display device of claim 14, wherein each of the inner side surface and the outer side surface is a flat or curved surface, and the first connection side surface and the second connection side surface are flat surfaces.

18. The liquid crystal display device of claim 14, wherein a line extending to the light source along the first connection side surface and a line extending to the light source along the second connection side surface pass through an inside of the light source.

19. The liquid crystal display device of claim 15, wherein the support members comprise first, second, third, and fourth support members,
wherein the first support members and the third support members are symmetrically located with respect to a center of the light source, and the second support members and the fourth support members are symmetrically located with respect to the light source, and
wherein a distance between the first support members and the fourth support member in a width direction of the substrate is smaller than a distance between the first support members and the second support members in a longitudinal direction of the substrate

20. The liquid crystal display device of claim 14, further comprising:
a bottom chassis accommodating the light source system; and
a reflective sheet disposed on the bottom chassis, the reflective sheet surrounding the lens.

21. The light source system of claim 1, wherein the area of the outer side surface is larger than the area of the inner side surface.

22. The light source system of claim 1, wherein the light emitted by the light source that enters the inner side surface of a support member generally exits the support member via the outer side surface thereof.
